(19) United States
(12) Patent Application Publication
(10) Pub. No.: US 2018/0285553 A1
(43) Pub. Date: Oct. 4, 2018

(54) SOFTWARE PROTECTION SYSTEM AND METHOD

(71) Applicant: HONGFUJIN PRECISION ELECTRONICS (TIANJIN) CO.,LTD., Tianjin (CN)

(72) Inventor: ZHEN-ZHU ZHANG, Shenzhen (CN)

(21) Appl. No.: 15/497,295

(22) Filed: Apr. 26, 2017

(30) Foreign Application Priority Data
Mar. 28, 2017 (CN) 201710193963.1

(51) Int. Cl. G06F 21/44; G06F 21/45

(52) U.S. Cl. CPC G06F 21/44; G06F 21/45

(57) ABSTRACT

A software protection system includes a user terminal and a server. According to an authorization request from the user terminal as to target software, the server generates an encrypted authorization file and an executable file of the target software. When the executable file is to be run at a terminal, a determination is made as to whether the physical information of the terminal and information as to the target software are same as that in the encrypted authorization file. When the information are same, the running of the executable file is permitted. The disclosure further provides a software protection method.

### CROSS-REFERENCE TO RELATED APPLICATIONS

This application claims priority to Chinese Patent Application No. 201710193963.1, filed on Mar. 28, 2017, the contents of which are incorporated by reference herein.

### FIELD

The subject matter herein generally relates to software protection systems and method.

### BACKGROUND

Software piracy can be combated in a hardware mode. The software and an encryption card corresponding to the software are sold to a user. When the user uses the software, the encryption card must be inserted to a port of a computer. Thus, a number of available ports is reduced.

### BRIEF DESCRIPTION OF THE DRAWINGS

Implementations of the present technology will now be described, by way of example only, with reference to the attached figures.

FIG. 1 is a schematic diagram of a software protection system.

FIG. 2 is a block diagram of the software protection system in FIG. 1, according to an exemplary embodiment.

FIG. 3 is a block diagram of the software protection system in FIG. 1, according to another exemplary embodiment.

FIG. 4 is a flowchart of a software protection method, according to an exemplary embodiment.

FIG. 5 is a flowchart of a software protection method, according to another exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the exemplary embodiments described herein.

A definition that applies throughout this disclosure will now be presented.

The term “comprising” means “including, but not necessarily limited to”; it specifically indicates open-ended inclusion or membership in a so-described combination, group, series, and the like.

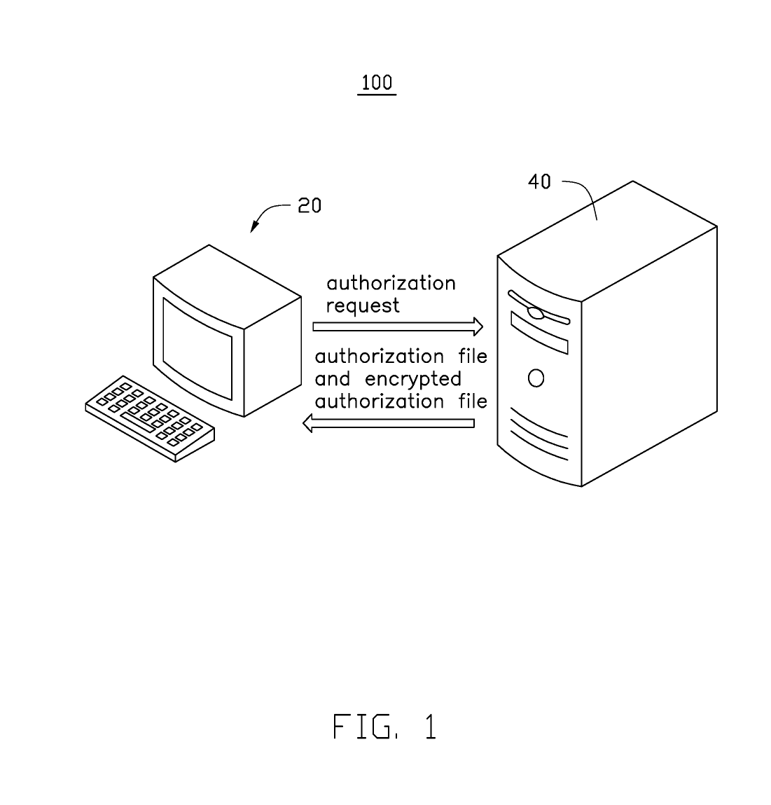

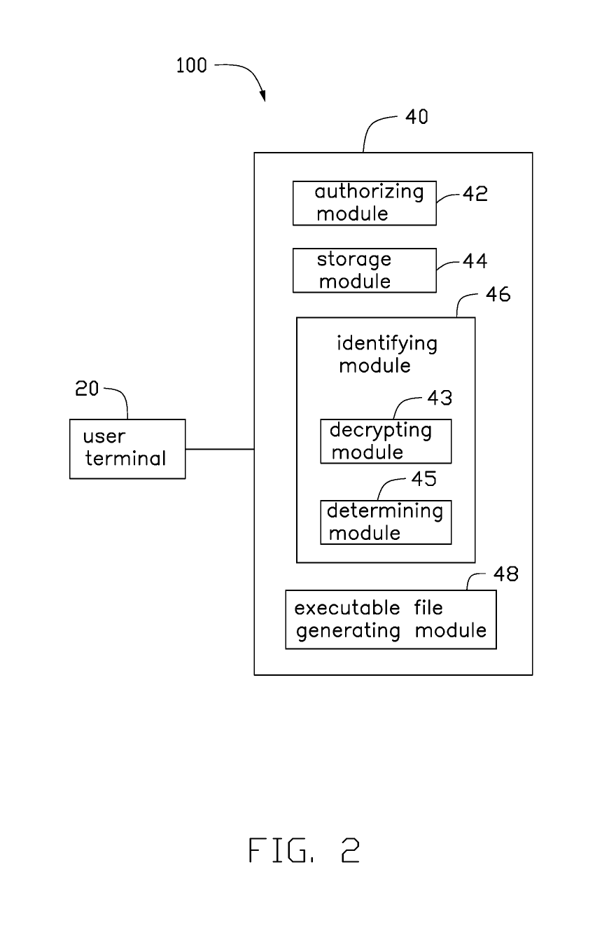

FIGS. 1 and 2 illustrate a software protection system 100. The software protection system 100 includes a user terminal 20 and a server 40 communicating with the user terminal 20. The server 40 provides software to the user terminal 20. The software protection system 100 prevents the software from being pirated.

The user terminal 20 sends an authorization request in relation to target software to the server 40. The authorization request includes physical information of the user terminal 20 and information as to the target software. The physical information of the user terminal 20 is unique. The physical information of the user terminal 20 can be a serial number of a hard disk of the user terminal 20, a serial number of a central processing unit or a MAC address of the user terminal 20.

The server 40 includes an authorizing module 42, an identifying module 46, a storage module 44, and an executable file generating module 48. The storage module 44 stores the target software. According to the authorization request, the authorizing module 42 generates an encrypted authorization file. The encrypted authorization file can be decrypted to allow a user to access the target software. The encrypted authorization file includes the physical information of the user terminal 20 and the information as to the target software. The executable file generating module 48 loads the target software and the identifying module 46 to generate an executable file of the target software. The server 40 transmits the encrypted authorization file and the executable file to the user terminal 20.

The identifying module 46 includes a decrypting module 43 and a determining module 45. The decrypting module 43 is configured to decrypt the encrypted authorization file. When the executable file is executed on a terminal, the determining module 45 determines whether the terminal has the encrypted authorization file corresponding to the executable file. When the terminal has the encrypted authorization file, the module 45 determines whether the physical information of the terminal and the information as to the target software in the execute file are present and are the same as the physical information and the software information.

When the physical information of the terminal and the information as to the target software in the execute file are same as the physical information and the information as to software in the encrypted authorization file, the determining module 45 determines that the encrypted authorization file is present and available, the executable file is allowed to run and the target software is accessed. Otherwise, the determining module 45 determines that the encrypted authorization file is unavailable, and the executable file will be stopped from running.

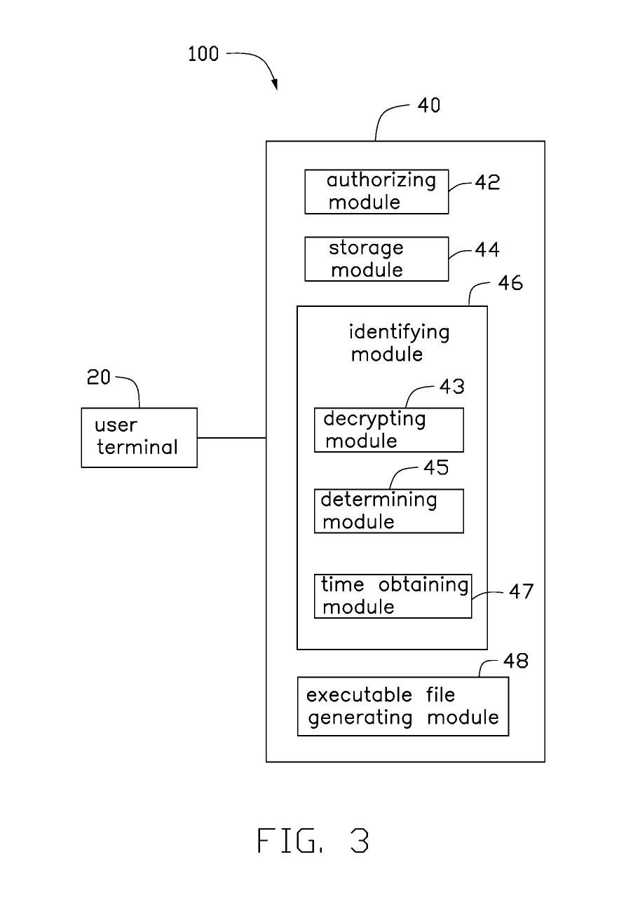

The information as to the target software includes a name and version of the target software. FIG. 3 illustrates that the information of the target software further includes an expiry date. According to information of the user requesting the authorization, the server 40 determines the expiry date. The information of the user may include a fee for the target software. The determining module 45 further determines whether the terminal executing the executable file is connected to the server 40, and when the terminal executing the executable file is not connected to the server 40, determines that the encrypted authorization file is unavailable. The identifying module 46 further includes a time obtaining module 47. When the terminal executing the executable file is connected to the server 40, the time obtaining module 47 obtains clock information of the server 40.

The determining module 45 further determines whether the clock information of the server 40 is within the expiry date of the target software in the decrypted authorization file. When the clock information of the server 40 is within the expiry date of the target software (that is, the expiry date has not yet occurred) in the decrypted authorization file, the determining module 45 determines that the encrypted authorization file is available. Otherwise, the determining module 45 determines that the encrypted authorization file is unavailable. The server 40 further records information as to the terminal and the clock information.

The target software includes a number of function modules. The encrypted authorization file further includes a permit to use the target software. According to information of the user requesting the authorization, the server 40 determines the permit to use the target software. The information of the user may include the fee paid or payable for the target software. The permit to use the target software sets which function module is available. When the encrypted authorization file is available, according to the permit to use the target software, the available function module can be accessed.

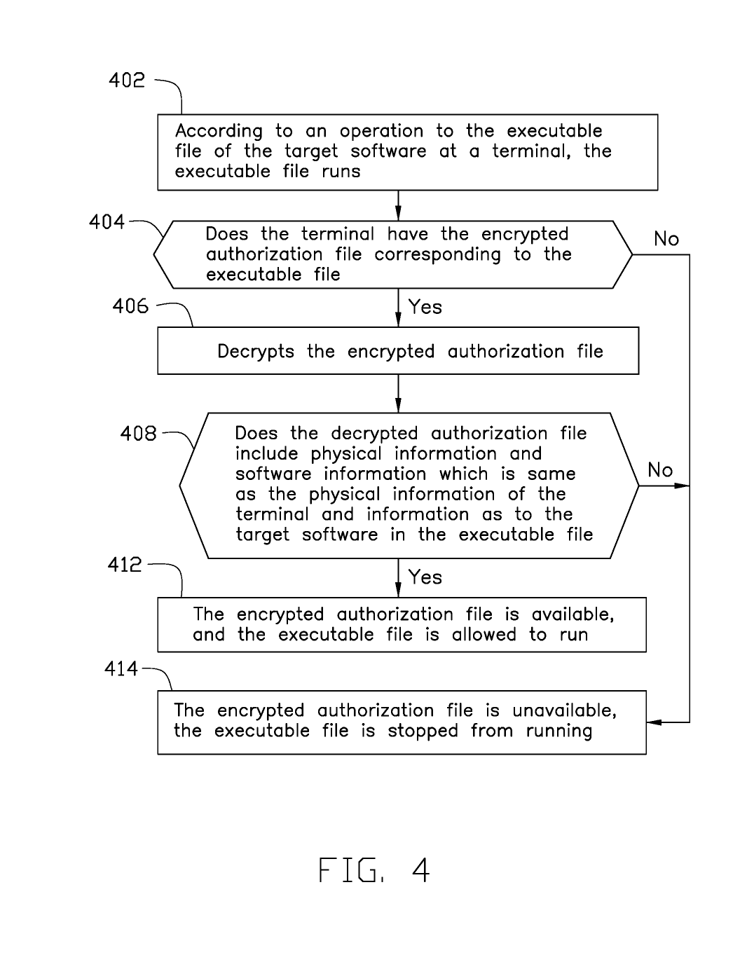

FIG. 4 illustrates a software protection method according to an embodiment. The order of blocks in FIG. 4 is illustrative only and the order of the blocks can change. Additional blocks can be added or fewer blocks may be utilized without departing from this disclosure. The exemplary method begins at block 402.

At block 402, according to an opening operation at a terminal, the executable file of target software runs.

At block 404, the determining module 45 determines whether the terminal has the encrypted authorization file corresponding to the executable file. When the terminal has the encrypted authorization file corresponding to the executable file, the procedure goes block 406. Otherwise, the procedure goes block 414.

At block 406, the decrypting module 43 decrypts the encrypted authorization file.

At block 414, the determining module 45 determines that the encrypted authorization file is unavailable, the executable file is stopped from running.

At block 408, the determining module 45 determines whether the decrypted authorization file includes physical information and software information which is same as the physical information of the terminal and information as to the target software in the executable file. The information of the target software includes a name and version of the target software.

When the decrypted authorization file includes physical information and software information which is same as that in the executable file, the procedure goes block 412. Otherwise, the procedure goes to block 414.

At block 412, the determining module 45 determines that the encrypted authorization file is available, and the executable file is allowed to run.

The target software includes a number of function modules. The decrypted authorization file further includes a permit to use the target software. The permit to use the target software sets which function module is available. When the encrypted authorization file is available, according to the permit to use the target software, the available function module can be accessed.

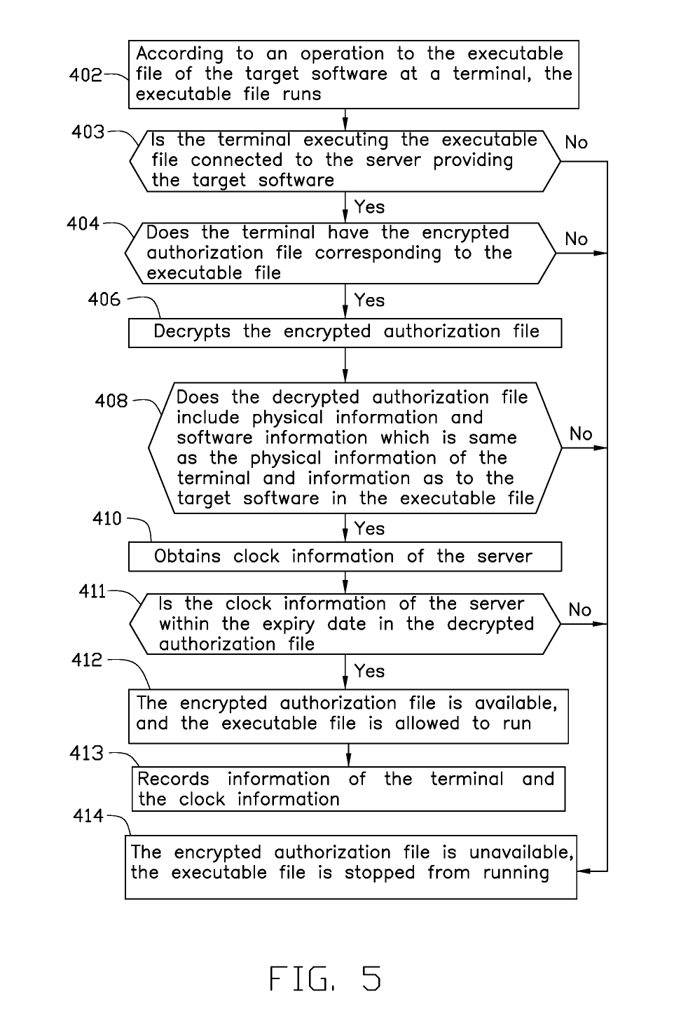

FIG. 5 is a flowchart of a software protection method, according to another exemplary embodiment. The encrypted authorization file further includes the expiry date of the target software. The method further includes block 403, block 411, and block 413.

At block 403, the determining module 45 determines whether the terminal executing the executable file is connected to the server 40 providing the target software. When the terminal executing the executable file is connected to the server 40, the procedure goes to block 404. Otherwise, the procedure goes to block 414.

At block 410, the time obtaining module 47 obtains clock information of the server 40.

At block 411, the determining module 45 determines whether the clock information of the server 40 is within the expiry date in the decrypted authorization file. When the clock information of the server 40 indicates that usage of the target software is within the expiry date in the decrypted authorization file, the procedure goes to block 412. Otherwise, the procedure goes to block 414.

At block 413, the server 40 records information of the terminal and the clock information.

The embodiments shown and described above are only examples. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A software protection system comprising:
a user terminal configured to send an authorization request of a target software, wherein the authorization request comprises physical information of the user terminal and information of the target software; and
a server configured to receive the authorization request, the server comprising:
a storage module configured to store the target software;
an authorizing module configured to generates an encrypted authorization file according to the authorization request of target software, the encrypted authorization file being decrypted to allow a user to access the target software, the encrypted authorization file comprising the physical information of the user terminal and the information of the target software;
an identifying module comprising a decrypting module and a determining module; and
an executable file generating module configured to load the target software and the identifying module to generate an executable file of the target software;
wherein the server transmits the encrypted authorization file and the executable file to the user terminal, the decrypting module decrypts the encrypted authorization file, when the executable file is executed on a terminal, the determining module determines whether the terminal has the encrypted authorization file corresponding to the executable file, and when the terminal has the encrypted authorization file, the determining module determines whether the physical information of the terminal and the information of the target software in the execute file are same as the physical information and the information of software in the encrypted authorization file, wherein when the physical information of the terminal and the information of the target software in the execute file are same as the physical information and the information of software in the encrypted authorization file, the determining module determines the encrypted authorization file is available and the execute file is allowable to continue run and the target software is accessed.

2. The software protection system as claimed in claim 1, wherein the information of the target software further comprises an expiry date, according to information of the user requesting the authorization request, the server determines the expiry date, the determining module further determines whether the terminal executing the executable file is connected to the server, the identifying module further comprises a time obtaining module, when the terminal executing the executable file is connected to the server, the time obtaining module obtains clock information of the server, the determining module further determines whether the clock information of the server is within the expiry date of the target software in the decrypted authorization file, when the clock information of the server is within the expiry date of the target software in the decrypted authorization file, the determining module determines the encrypted authorization file is available.

3. The software protection system as claimed in claim 2, wherein when the terminal executing the executable file is not connected to the server, the determining module determines the encrypted authorization file is unavailable, the execute file stops running and the target software cannot be accessed.

4. The software protection system as claimed in claim 2, wherein the server records information of the terminal and the clock information.

5. The software protection system as claimed in claim 2, wherein the information of the user comprises a fee paid for the target software.

6. The software protection system as claimed in claim 1, wherein the physical information of the user terminal is a serial number of a central processing unit.

7. The software protection system as claimed in claim 1, wherein the physical information of the user terminal is a serial number of a hard disk of the user terminal.

8. The software protection system as claimed in claim 1, wherein the physical information of the user terminal is a MAC address of the user terminal.

9. The software protection system as claimed in claim 1, wherein the information of the target software comprises a name and version of the target software.

10. The software protection system as claimed in claim 1, wherein the target software comprises a plurality of function modules, the encrypted authorization file further comprise a using permission of the target software, the using permission of the target software sets which function module is available, when the encrypted authorization file is available, according to the using permission of the target software, the available function module can be accessed.

11. A software protection method comprising:
according to an opening operation t at a terminal, running an executable file of target software;
determining whether the terminal has an encrypted authorization file corresponding to the executable file;
when the terminal has the encrypted authorization file corresponding to the executable file, decrypting the encrypted authorization file;
determining whether the decrypted authorization file comprises physical information and software information same as physical information of the terminal and information of the target software in the executable file; and
when the decrypted authorization file comprises physical information and software information same as physical information of the terminal and information of the target software in the executable file, determining the encrypted authorization file being available, the execute file being allowable to continue run and the target software being accessed.

12. The software protection method as claimed in claim 11, wherein the information of the target software further comprises an expiry date, the method further comprises:
determining whether the terminal executing the executable file is connected to a server providing the target software;
when the terminal executing the executable file is connected to the server, obtaining clock information of the server;
determining whether the clock information of the server is within the expiry date of the target software in the decrypted authorization file;
when the clock information of the server is within the expiry date of the target software in the decrypted authorization file, determining the encrypted authorization file is available.

13. The software protection method as claimed in claim 12, further comprising:
when the terminal executing the executable file is not connected to the server, determining the encrypted authorization file being unavailable, the execute file stops running and the target software cannot be accessed.

14. The software protection method as claimed in claim 12, further comprising:
recording information of the terminal and the clock information.

15. The software protection method as claimed in claim 12, wherein the information of the user comprises a fee paid for the target software.

16. The software protection method as claimed in claim 11, wherein the physical information of the user terminal is a serial number of a central processing unit.

17. The software protection method as claimed in claim 11, wherein the physical information of the user terminal is a serial number of a hard disk of the user terminal.

18. The software protection method as claimed in claim 11, wherein the physical information of the user terminal is a MAC address of the user terminal.

19. The software protection method as claimed in claim 11, wherein the information of the target software comprises a name and version of the target software.

20. The software protection method as claimed in claim 11, wherein the target software comprises a plurality of function modules, the encrypted authorization file further comprise a using permission of the target software, the using permission of the target software sets which function module is available, when the encrypted authorization file is available, according to the using permission of the target software, the available function module can be accessed.
